(19) United States
(12) Patent Application Publication
(10) Pub. No.: US 2020/0370793 A1
(43) Pub. Date: Nov. 26, 2020

(54) STIRLING COOLER AND SEALING STRUCTURE THEREOF

(71) Applicant: TamKang University, New Taipei City (TW)

(72) Inventors: SHUNG-WEN KANG, Taipei City (TW); CHUN-LIN CHANG, New Taipei City (TW)

(21) Appl. No.: 16/515,108

(22) Filed: Jul. 18, 2019

(30) Foreign Application Priority Data
May 22, 2019 (TW) 108117735

(51) Int. Cl. F25B 9/14; F02G 1/053; F02G 1/057

(52) U.S. Cl. CPC F25B 9/14; F02G 2253/06; F02G 1/057; F02G 1/0535

(57) ABSTRACT

A sealing structure for a Stirling cooler includes a bellows, a first connecting block disposed at an end of the bellows, and a second connecting block disposed at another end of the bellows. The sealing structure for a Stirling cooler can generate both off-axis movements and lateral movements so as to produce corresponding harmonic motions, such that vibrations can be isolated, excellent vacuum can be obtained, and superior sealing quality can be ensured. Thereupon, possible leakage for the Stirling cooler operated under a significant pressure difference can be substantially resolved.

### CROSS REFERENCE TO RELATED APPLICATION

This application claims the benefits of Taiwan application Serial No. 108117735, filed on May 22, 2019, the disclosures of which are incorporated by references herein in its entirety.

### TECHNICAL FIELD

The present disclosure relates in general to a Stirling cooler and a sealing structure thereof, and more particularly to the Stirling cooler that utilizes the sealing structure to resolve a leakage problem caused by a significant operational pressure difference upon the cooler.

### BACKGROUND

Currently, the small scale Cryocooler or cooler market by type is segmented at least into Joule-Thomson (JT), Brayton, Gifford-McMahon (GM), Pulse-Tube (PT) and Stirling. In addition, the heat transfer pattern for these coolers can be recuperative or regenerative.

In a recuperative heat transfer pattern, cool and hot fluids are separated into different paths, and heat exchange occurs across the wall separating these two fluids. On the other hand, in a regenerative heat transfer pattern, the working fluid experiences heat exchange via reciprocally flowing through a regenerative material. The regenerative heat transfer pattern is featured in compact structuring and high heat-exchange efficiency. In particular, the aforesaid Stirling cooler is a regenerative cooler. Generally, a commercialized Stirling cooler usually has a gross weight less than 1 kg. Further, with a superior miniaturization to other types of coolers, since the Stirling cooler is furnished with no sealing valve for circulation, thus the service life as well as the reliability can be significantly improved. For example, the service life of a typical Stirling cooler can be extended at least to ten years. To a cooling capacity demand of 1 W for 20K˜100K, the Stirling cooler is one of good choices.

The Stirling cooler, adopting a reverse Stirling cycle for a closed gas circulation, is to expand and/or compress the working gas by a piston driven by a motor. A displacer is provided to a cool gas end of the Stirling cooler so as to flow the gas reciprocally, and thus to form internally a high-low temperature pair with a regenerator.

The Stirling cooler usually has a filling pressure within 5˜20 atm. In the art, the higher the filling pressure is, the more a cooling capacity the Stirling cooler can have. Since the piston and the displacer are to carry out reciprocating motions with different phases, this the Stirling cooler does face inevitable problems in oscillation and leakage.

### SUMMARY

Accordingly, an object of the present disclosure is to provide a Stirling cooler and a sealing structure thereof that the sealing structure for the Stirling cooler can generate both off-axis movements and lateral movements, so that, upon external forces and moments, corresponding harmonic motions can be formed to resolve potential leakage for the Stirling cooler under a large operational pressure difference.

In this disclosure, a sealing structure for a Stirling cooler includes:

a bellows;

a first connecting block, disposed at one end of the bellows; and

a second connecting block, disposed at another end of the bellows.

In one embodiment of this disclosure, the bellows the bellows is formed by piling orderly a plurality of annular hollow sealing elements in an overlapping manner by welding. Each of the plurality of sealing elements is individually manufactured by punching upon a thin plate firstly, and then a plurality of the punched sealing elements is piled together orderly in the overlapping manner by precisely welding an inner rim of one said sealing element (the instant sealing element) with another inner rim of a preceding/following sealing element and an outer rim of the instant sealing element with another outer rim of the following/preceding sealing element. The bellows has thereinside a sealed space with a predetermined pressure ranging from 5 to 20 atm.

In one embodiment of this disclosure, the first connecting block has a sealing groove and a plurality of positioning holes, the sealing groove furnished to a side of the first connecting block away from the bellows is installed thereinside by an O-ring, and the plurality of positioning holes is distributed to surround the sealing groove.

In this disclosure, an embodiment of the Stirling cooler includes:

a cooling cylinder, having thereinside an expansion chamber, a displacer and a regenerator, the displacer being furnished outside to the regenerator, a cooling head being provided exterior to the cooling cylinder; and

a compression cylinder, having thereinside a compression chamber, a connecting mechanism and a sealing structure for a Stirling cooler, the connecting mechanism connecting the sealing structure, the compression chamber being communicated spatially with the cooling cylinder, the sealing structure being connected with the regenerator, the sealing structure having a bellows, a first connecting block disposed at an end of the bellows, and a second connecting block disposed at another end of the bellows.

In one embodiment of this disclosure, the connecting mechanism has a rhomhic drive linkage and two flywheels, the two flywheels connects the rhomhic drive linkage and a power source, the rhomhic drive linkage further connects the sealing structure, and the sealing structure has a connection mechanism that passes the compression chamber to connect the regenerator.

In one embodiment of this disclosure, the compression cylinder further has thereinside a first compression chamber, the first compression chamber communicates spatially with the compression chamber via a connection pipe, the connecting mechanism has a first connection bar, a second connection bar and a flywheel, one end of the first connection bar protrudes into the compression chamber to connect the regenerator, another end of the first connection bar is connected with the flywheel, and the second connection bar connects the sealing structure to the flywheel.

In one embodiment of this disclosure, the cooling cylinder further has a hot chamber and a transmission mechanism, the transmission mechanism disposed inside the hot chamber is connected with the regenerator, and the compression chamber is communicated spatially with the hot chamber via a pipeline.

In one embodiment of this disclosure, the sealing structure has a connection bar protruding into the compression chamber to connect the regenerator, and the connecting mechanism coupling the sealing structure is a spring mechanism

As stated, the Stirling cooler and the sealing structure thereof are provided in this disclosure. While the Stirling cooler meets external forces and moments, both off-axis movements and lateral movements can be generated so as to produce corresponding harmonic motions, such that vibrations can be isolated, excellent vacuum can be obtained, and superior sealing quality can be ensured. Thereupon, possible leakage for the Stirling cooler operated under a significant pressure difference can be substantially resolved.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of a sealing structure for a Stirling cooler with a portion thereof shown cross-sectionally in accordance with this disclosure;

FIG. 2 is a schematic view of a first embodiment of the Stirling cooler in accordance with this disclosure;

FIG. 3 is a schematic view of a second embodiment of the Stirling cooler in accordance with this disclosure;

FIG. 4 is a schematic view of a third embodiment of the Stirling cooler in accordance with this disclosure;

FIG. 5 is a schematic view of a fourth embodiment of the Stirling cooler in accordance with this disclosure;

FIG. 6 shows a testing for a positive-pressure leakage upon a Stirling cooler in accordance with this disclosure;

FIG. 7 is a plot showing a testing of a Stirling cooler at 900 rpm in accordance with this disclosure; and

FIG. 8 is a plot of temperature variations of a bellows in a compression chamber in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

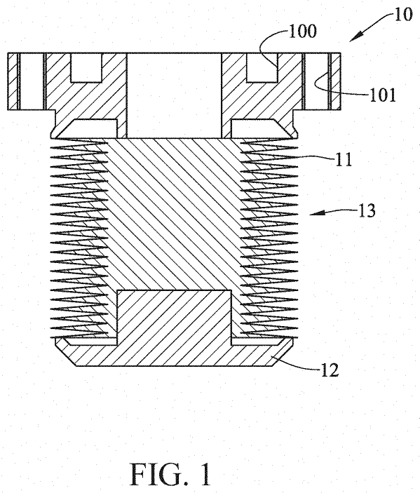

Referring now to FIG. 1, a sealing structure for a Stirling cooler in accordance with this disclosure includes a first connecting block 10, a plurality of annular hollow sealing elements 11 and a second connecting block 12.

In producing the bellows 13, each of the sealing elements 11 is individually manufactured by punching upon a thin plate firstly, and then a plurality of the punched sealing elements 11 are piled together orderly in an overlapping manner by precisely welding an inner rim of one instant sealing element 11 with another inner rim of the preceding/following sealing element 11 and an outer rim of the instant sealing element 11 with another outer rim of the following/preceding sealing element 11. A length of the bellows 13 is determined according to required longitudinal displacement, stress and stiffness.

The first connecting block 10, disposed at one end of the bellows 13, has a sealing groove 100 and a plurality of positioning holes 101. The sealing groove 100 is furnished to a side of the first connecting block 10 away from the bellows 13 so as to install there-along an O-ring. The positioning holes 101 are distributed to surround the sealing groove 100.

The second connecting block 12, disposed at another end of the bellows 13, is used to form an internal sealing space inside the bellows 13. The sealing space has a predetermined pressure, preferably ranging from 5 to 20 atm.

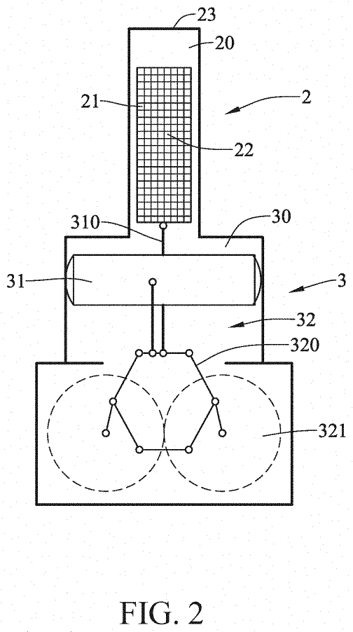

Referring now to FIG. 2, a first embodiment of the Stirling cooler in accordance with this disclosure includes a cooling cylinder 2 and a compression cylinder 3.

The cooling cylinder 2 has thereinside an expansion chamber 20, a displacer 21 and a regenerator 22. The displacer 21 is furnished outside to the regenerator 22, and a cooling head 23 is provided exterior to the cooling cylinder 2.

The compression cylinder 3 has thereinside a compression chamber 30, a sealing structure 31 for the Stirling cooler and a connecting mechanism 32. The compression chamber 30 is communicated spatially with the cooling cylinder 2, and the displacer 21 and the regenerator 22 are located between the expansion chamber 20 and the compression chamber 30. The sealing structure 31 for the Stirling cooler has a connection mechanism 310 that passes through the compression chamber 30 to connect the regenerator 22. The connecting mechanism 32 has a rhomhic drive linkage 320 and two flywheels 321. One end of the rhomhic drive linkage 320 is connected to the sealing structure 31, and another end of the rhomhic drive linkage 320 is coupled with the two flywheels 321, which are further to connect a power source (not shown in the figure).

As shown in FIG. 2, the sealing structure 31 is driven by the connecting mechanism 32 to undergo reciprocating motions so as to drive further the displacer 21 and the regenerator 22 to proceed the reciprocating motions. Thereupon, an internal working fluid can be flowed reciprocally in a predetermined period so as to form a pressure difference.

As described, the working fluid would flow back and forth around the expansion chamber 20 and the compression chamber 30 in accordance with the reciprocating motions of the displacer 21. As the working fluid is expanded in the expansion chamber 20, the corresponding pressure would go down while the corresponding temperature would be lowered. On the other hand, as the working fluid is compressed in the compression chamber 30, the corresponding pressure would go up while the corresponding temperature would be raised. Thereupon, the thermal energy would be exhausted to the atmosphere through the aforesaid heat-dissipation mechanism, in either a water-cooling manner or a gas-cooling manner

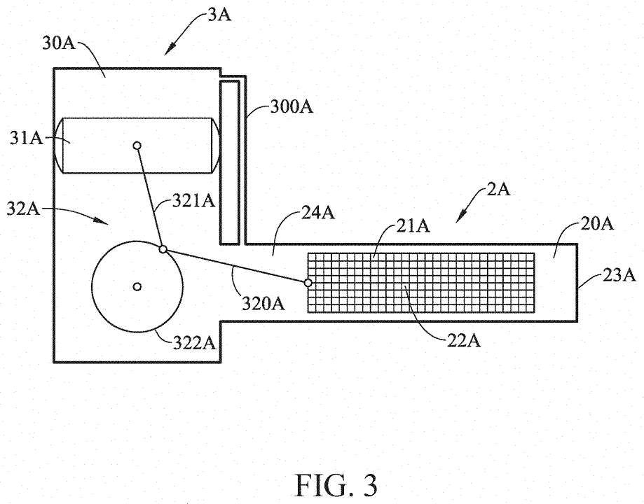

Referring now to FIG. 3, a second embodiment of the Stirling cooler in accordance with this disclosure includes a cooling cylinder 2A and a compression cylinder 3A. In this embodiment, operations of the Stirling cooler are substantially resembled to those of the aforesaid first embodiment described above, and thus details thereabout are omitted herein.

The cooling cylinder 2A has thereinside an expansion chamber 20A, a displacer 21A, a regenerator 22A and a compression chamber 24A. The displacer 21A and the regenerator 22A are disposed between the expansion chamber 20A and the compression chamber 24A, and a cooling head 23A is provided to top externally the cooling cylinder 2A.

The compression cylinder 3A has thereinside a first compression chamber 30A, a sealing structure 31A for the Stirling cooler and a connecting mechanism 32A. The first compression chamber 30A is connected spatially with the compression chamber 24A via a connection pipe 300A. The sealing structure 31A is disposed at one end of the first compression chamber 30A. Preferably, the sealing structure 31A is located under the first compression chamber 30A. The connecting mechanism 32A has a first connection bar 320A, a second connection bar 321A and a flywheel 322A. One end of the first connection bar 320A protrudes into the compression chamber 24A so as to connect the regenerator 22A thereinside, while another end of the first connection bar 320A is connected with the flywheel 322A. The second connection bar 321A is used to connect the sealing structure 31A to the flywheel 322A.

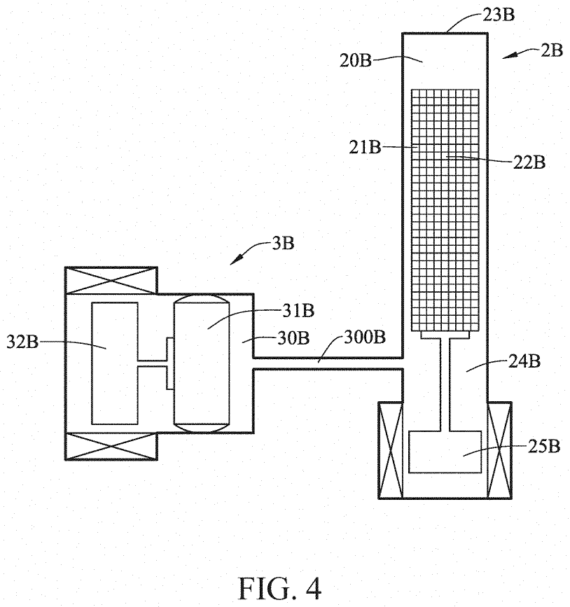

Referring now to FIG. 4, in the third embodiment, the Stirling cooler includes a cooling cylinder 2B and a compression cylinder 3B. In this embodiment, operations of the Stirling cooler are substantially resembled to those of the aforesaid first embodiment described above, and thus details thereabout are omitted herein.

The cooling cylinder 2B has thereinside an expansion chamber 20B, a displacer 21B, a regenerator 22B, a hot chamber 24B and a transmission mechanism 25B. The displacer 21B and the regenerator 22B are disposed between the expansion chamber 20B and the hot chamber 24B. The transmission mechanism 25B, disposed in the hot chamber 24B, is connected with the regenerator 22B. A cooling head 23B is furnished exterior to top the cooling cylinder 2B.

The compression cylinder 3B has thereinside a compression chamber 30B, a sealing structure 31B and a connecting mechanism 32B. The compression chamber 30B is communicated spatially with the hot chamber 24B via a pipeline 300B. Both the connecting mechanism 32B and the sealing structure 31 are disposed inside the compression chamber 30B. The sealing structure 31B to be located at one side of the compression chamber 30B, and the connecting mechanism 32B, connected with the sealing structure 31B is located at another side thereof.

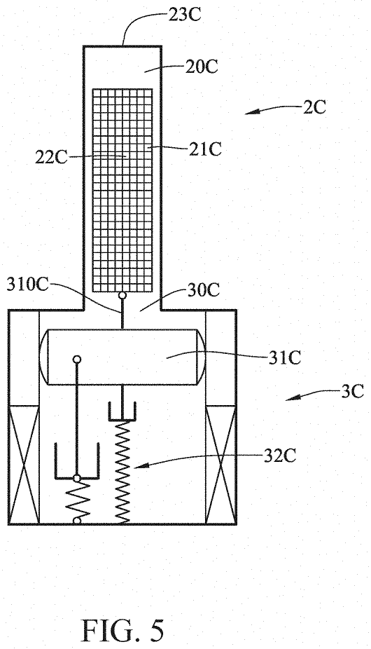

Referring now to FIG. 5, in the fourth embodiment, the Stirling cooler includes a cooling cylinder 2C and a compression cylinder 3C. In this embodiment, operations of the Stirling cooler are substantially resembled to those of the aforesaid first embodiment described above, and thus details thereabout are omitted herein.

The cooling cylinder 2C has thereinside an expansion chamber 20C, a displacer 21C and a regenerator 22C. The cooling cylinder 2C has an exterior cooling head 23C.

Inside the compression cylinder 3C, a compression chamber 30C, a sealing structure 31C and a connecting mechanism 32C are included. The compression chamber 30C is communicated spatially with the cooling cylinder 2C. The sealing structure 31C protrudes a connection bar 310C thereof into the compression chamber 30C so as to be connected with the regenerator 22C. The connecting mechanism 32C, coupling the sealing structure 31C, can be embodied as a spring mechanism.

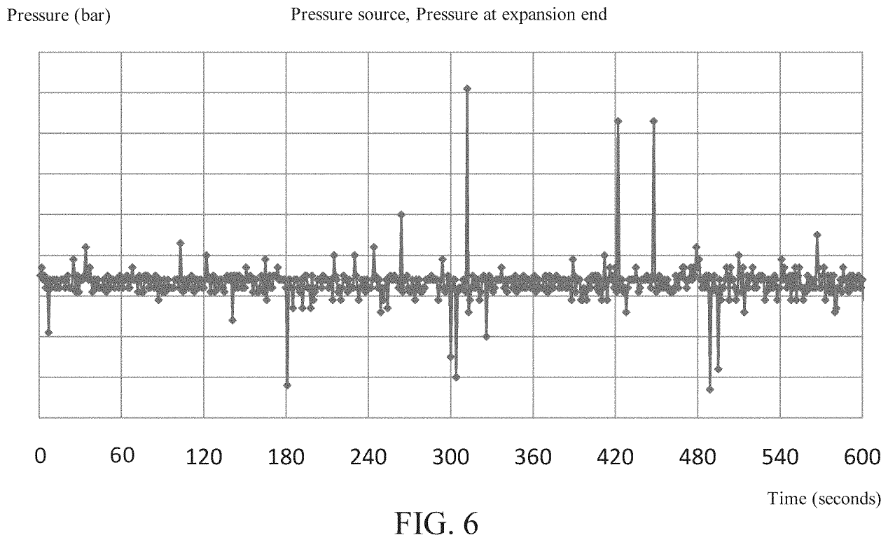

Referring now to FIG. 6, testing results of positive-pressure leakage are shown. In this testing, the bellows for the Stirling cooler is filled with Helium at a filling pressure of 7.55 bar, a pressure for the pressure equalizing chamber is 7.3 bar, a data collecting time (testing time) is 10 minutes, a gross data number (testing number) is 600, a leakage rate is −1.67e-5 bar/second (=−0.001 bar/minute), and an average pressure is 7.53223 bar. As shown in FIG. 6, it is noted that, even under a high pressure of 7.55 bar, the bellows provided by this disclosure still meets no leakage.

As mentioned, in FIG. 6, the overall average pressure is 7.53223 bar. Also, it is noted that, except for some specific points, the pressures do not exhibit significant changes. At these points where pulse-up or pulse-down pressures are presented, it is believed that these abnormal pressures can be treated as noises of the detection, and thus would be ignored. The reason is that, with a low sampling frequency, the sampling points are actually determined in an arbitrary sense within the whole cycle, Thus, these points detected to have unusual pressures can be managed as noises that contribute no significant statistic meaning. As shown in the following table, it is revealed that the amplitudes or deviations of the listed data with respect to the average pressure is less than 0.5 bar. Thus, the entire system does not have a leakage problem.

Testing at 900 rpm

| | | Pressure | | | | | | | |
|---|---|---|---|---|---|---|---|---|---|
| | | source, | | Inlet | Outlet | Bellows | Bellows | Outlet | Inlet |
| | | Pressure | Pressure | pressure | pressure | temperature | temperature | temperature | temperature |
| | | at | at | of | of | at | at | of | of |
| Time | | expansion | cooling | regenerator | regenerator | expansion | cooling | regenerator | regenerator |
| (seconds) | | end (Pi1) | end (Pi2) | (Ph) | (PI) | end (Ti1) | end (Ti2) | (TI) | (Th) |
| 0.006667 | 1 | 7.17 | 7.03 | 6.97 | 6.79 | 24.3 | 23.5 | 24.9 | 24.9 |
| 1 | 150 | 9.11 | 7.4 | 8.39 | 7.16 | 28.7 | 24.9 | 24.2 | 25.6 |
| 2 | 300 | 8.63 | 7.31 | 7.79 | 7.04 | 29.2 | 25.1 | 24.2 | 25.8 |
| 3 | 450 | 8.03 | 7.39 | 7.28 | 7.01 | 29.7 | 25.1 | 24.4 | 25.8 |
| 4 | 600 | 7.49 | 7.26 | 6.9 | 6.98 | 29.9 | 25.1 | 24.4 | 25.8 |
| 5 | 750 | 7.09 | 7.31 | 6.65 | 7.01 | 30 | 25.1 | 24.7 | 26 |
| 6 | 900 | 6.81 | 7.37 | 6.49 | 7.09 | 30.3 | 25.1 | 24.7 | 26 |
| 7 | 1050 | 6.67 | 7.53 | 6.42 | 7.15 | 30.5 | 25.4 | 24.7 | 25.3 |
| 8 | 1200 | 6.46 | 7.73 | 6.26 | 7.4 | 30.6 | 25.4 | 24.7 | 26 |
| 9 | 1350 | 6.46 | 7.9 | 6.35 | 7.65 | 30.8 | 25.4 | 24.7 | 26 |
| 10 | 1500 | 6.46 | 8.24 | 6.43 | 7.88 | 30.9 | 25.4 | 24.7 | 26 |
| 11 | 1650 | 6.63 | 8.58 | 6.62 | 8.27 | 30.9 | 25.4 | 24.9 | 26.3 |
| 12 | 1800 | 6.84 | 8.86 | 6.86 | 8.48 | 31 | 25.4 | 24.7 | 26.3 |
| 13 | 1950 | 7.11 | 9.14 | 7.2 | 8.78 | 31.1 | 25.4 | 24.9 | 26.3 |
| 14 | 2100 | 7.46 | 9.32 | 7.61 | 9.04 | 31.2 | 25.4 | 24.7 | 26.3 |
| 15 | 2250 | 7.86 | 9.47 | 8.07 | 9.14 | 31.4 | 25.6 | 24.9 | 26.3 |
| 16 | 2400 | 8.3 | 9.47 | 8.59 | 9.14 | 31.5 | 25.4 | 24.9 | 26.3 |
| 17 | 2550 | 8.81 | 9.32 | 9.1 | 9.06 | 31.4 | 25.6 | 24.9 | 26.3 |
| 18 | 2700 | 9.38 | 9.16 | 9.55 | 8.95 | 31.5 | 25.6 | 24.9 | 26.5 |
| 19 | 2850 | 9.87 | 9.02 | 9.92 | 8.57 | 31.6 | 25.4 | 24.9 | 26.3 |
| 20 | 3000 | 10.28 | 8.82 | 10.18 | 8.38 | 31.6 | 25.4 | 24.7 | 26.3 |
| 21 | 3150 | 10.73 | 8.51 | 10.42 | 8.37 | 31.7 | 25.6 | 24.9 | 26.5 |
| 22 | 3300 | 10.87 | 8.26 | 10.53 | 8.13 | 31.7 | 25.6 | 24.9 | 26.5 |
| 23 | 3450 | 10.87 | 8.03 | 10.45 | 7.62 | 31.7 | 25.6 | 24.9 | 26.5 |
| 24 | 3600 | 10.65 | 7.7 | 10.18 | 7.68 | 31.7 | 25.6 | 24.9 | 26.5 |
| 25 | 3750 | 10.2 | 7.61 | 9.62 | 7.49 | 31.9 | 25.6 | 24.9 | 26.5 |

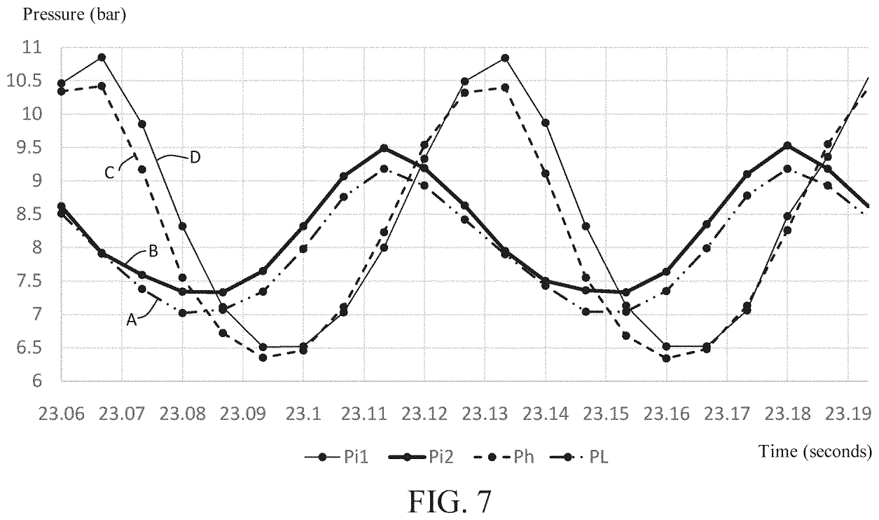

Referring now to FIG. 7, testing results (as listed above) at 900 rpm are provided in curves. In this testing, the filling gas is Helium, the filling pressure is 7.16 bar, the pressure equalizing chamber has a pressure of 7.14 bar, the data collecting time is 25 seconds, the gross data number is 3864, and the frequency is 1/150 Hz. In FIG. 7, curve A stands for the pressure source (i.e., the pressure at expansion end) Pi1, curve B stands for the pressure at cooling end Pi2, curve C stands for the inlet pressure of regenerator Ph, and curve D stands for the outlet pressure of regenerator Pl. As shown in FIG. 7, curve A is extended within a pressure range of 7˜9.3 bar, curve B is extended within a pressure range of 7.4˜9.5 bar, curve C is extended within a pressure range of 6.4˜10.4 bar, and curve D is extended within a pressure range of 6.5˜10.9.

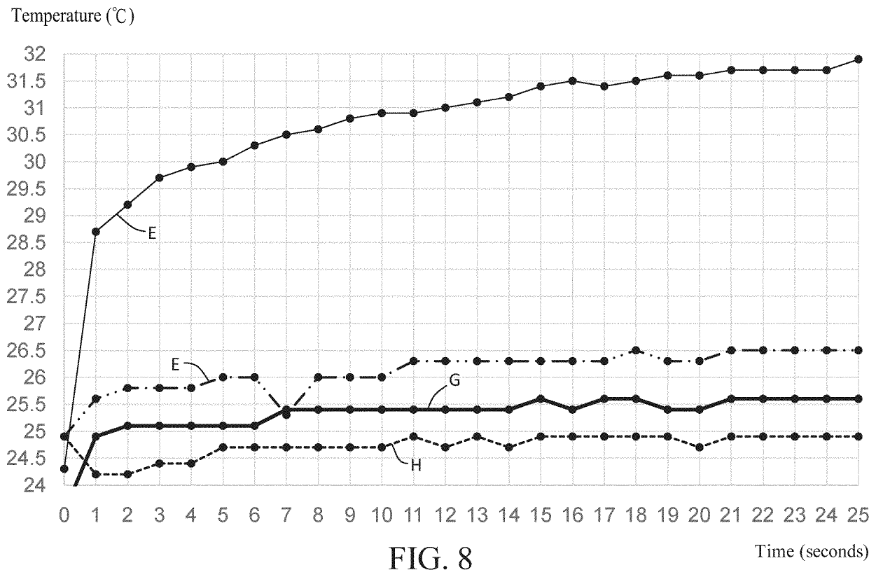

Referring now to FIG. 8, temperature changes of the bellows inside the compression chamber are shown. Curve E stands for variation of the temperature at the expansion end of the bellows Ti1, curve F stands for variation of the temperature at the inlet of the regenerator T1, curve G stands for variation of the temperature at the cooling end of the bellows Ti2, and curve H stands for variation of the temperature at the outlet of the regenerator Th. As shown, it is noted that the temperature at the expansion end of the bellows inside the compression chamber (curve E) keeps going higher and higher. It implies that the bellows performs work at the Helium so as to oscillate the Helium thereinside. With the oscillation of the Helium, the corresponding forcing would generate periodical changes. Thus, as the action time and the working cycles increase, thermal energy would be transferred from the expansion chamber to the compression chamber. In particular, while the Helium passes the regenerator, the heat of the regenerator would be transferred to the Helium, such that preheating for the next working cycle can be obtained. Thereupon, the energy can be saved, and the entire performance can be enhanced. In addition, temperature rises are also observed at the cooling end of bellows (curve G), the inlet of the regenerator (curve F) and the outlet of the regenerator (curve H). It implies that the work performed by the bellows does contribute to raise the temperatures inside the whole system.

In summary, the Stirling cooler and the sealing structure thereof are provided in this disclosure. The sealing structure for the Stirling cooler includes multiple layers of flexible thin plates. While in meeting external forces and moments, both the off-axis movements and the lateral movements can be generated so as to produce corresponding harmonic motions, such that vibrations can be isolated, excellent vacuum can be obtained, and superior sealing quality can be ensured. Thereupon, possible leakage for the Stirling cooler operated under a significant pressure difference can be substantially resolved.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A sealing structure for a Stirling cooler, comprising:
a bellows;
a first connecting block, disposed at an end of the bellows; and
a second connecting block, disposed at another end of the bellows.

2. The sealing structure for a Stirling cooler of claim 1, wherein the bellows is formed by piling orderly a plurality of annular hollow sealing elements in an overlapping manner by welding.

3. The sealing structure for a Stirling cooler of claim 2, wherein each of the plurality of sealing elements is individually manufactured by punching upon a thin plate firstly, and then a plurality of the punched sealing elements is piled together orderly in the overlapping manner by precisely welding an inner rim of one said sealing element (the instant sealing element) with another inner rim of a preceding/following sealing element and an outer rim of the instant sealing element with another outer rim of the following/preceding sealing element.

4. The sealing structure for a Stirling cooler of claim 1, wherein the bellows has thereinside a sealed space with a predetermined pressure.

5. The sealing structure for a Stirling cooler of claim 4, wherein the predetermined pressure is ranging from 5 to 20 atm.

6. The sealing structure for a Stirling cooler of claim 1, wherein the first connecting block has a sealing groove and a plurality of positioning holes, the sealing groove furnished to a side of the first connecting block away from the bellows is installed thereinside by an O-ring, and the plurality of positioning holes is distributed to surround the sealing groove.

7. A Stirling cooler, comprising:
a cooling cylinder, having thereinside an expansion chamber, a displacer and a regenerator, the displacer being furnished outside to the regenerator, a cooling head being provided exterior to the cooling cylinder; and
a compression cylinder, having thereinside a compression chamber, a connecting mechanism and a sealing structure for a Stirling cooler, the connecting mechanism connecting the sealing structure, the compression chamber being communicated spatially with the cooling cylinder, the sealing structure being connected with the regenerator, the sealing structure having a bellows, a first connecting block disposed at an end of the bellows, and a second connecting block disposed at another end of the bellows.

8. The Stirling cooler of claim 7, wherein the bellows is formed by piling orderly a plurality of annular hollow sealing elements in an overlapping manner by welding.

9. The Stirling cooler of claim 8, wherein each of the plurality of sealing elements is individually manufactured by punching upon a thin plate firstly, and then a plurality of the punched sealing elements is piled together orderly in the overlapping manner by precisely welding an inner rim of one said sealing element (the instant sealing element) with another inner rim of a preceding/following sealing element and an outer rim of the instant sealing element with another outer rim of the following/preceding sealing element.

10. The Stirling cooler of claim 7, wherein the bellows has thereinside a sealed space with a predetermined pressure.

11. The Stirling cooler of claim 10, wherein the predetermined pressure is ranging from 5 to 20 atm.

12. The Stirling cooler of claim 7, wherein the first connecting block has a sealing groove and a plurality of positioning holes, the sealing groove furnished to a side of the first connecting block away from the bellows is installed thereinside by an O-ring, and the plurality of positioning holes is distributed to surround the sealing groove.

13. The Stirling cooler of claim 7, wherein the connecting mechanism has a rhombic drive linkage and two flywheels, the two flywheels connects the rhomhic drive linkage and a power source, the rhomhic drive linkage further connects the sealing structure, and the sealing structure has a connection mechanism that passes the compression chamber to connect the regenerator.

14. The Stirling cooler of claim 7, wherein the compression cylinder further has thereinside a first compression chamber, the first compression chamber communicates spatially with the compression chamber via a connection pipe, the connecting mechanism has a first connection bar, a second connection bar and a flywheel, one end of the first connection bar protrudes into the compression chamber to connect the regenerator, another end of the first connection bar is connected with the flywheel, and the second connection bar connects the sealing structure to the flywheel.

15. The Stirling cooler of claim 7, wherein the cooling cylinder further has a hot chamber and a transmission mechanism, the transmission mechanism disposed inside the hot chamber is connected with the regenerator, and the compression chamber is communicated spatially with the hot chamber via a pipeline.

16. The Stirling cooler of claim 7, wherein the sealing structure has a connection bar protruding into the compression chamber to connect the regenerator, and the connecting mechanism coupling the sealing structure is a spring mechanism
